(19) United States
(12) Patent Application Publication
(10) Pub. No.: US 2023/0416142 A1
(43) Pub. Date: Dec. 28, 2023

(54) GLASS CERAMIC MATERIAL, LAMINATE, AND ELECTRONIC COMPONENT

(71) Applicant: Murata Manufacturing Co., Ltd., Nagaokakyo-shi (JP)

(72) Inventors: Sadaaki SAKAMOTO, Nagaokakyo-shi (JP); Yutaka SENSHU, Nagaokakyo-shi (JP); Hiroshige ADACHI, Nagaokakyo-shi (JP)

(21) Appl. No.: 18/463,703

(22) Filed: Sep. 8, 2023

Related U.S. Application Data
(63) Continuation of application No. PCT/JP2022/009046, filed on Mar. 3, 2022.

(30) Foreign Application Priority Data
Mar. 12, 2021 (JP) 2021-040275

(51) Int. Cl. C03C 10/00; B32B 18/00

(52) U.S. Cl. CPC C03C 10/0054; B32B 18/00

(57) ABSTRACT

A glass ceramic material that contains: glass containing SiO₂, B₂O₃, and M₂O, where M is an alkali metal; filler containing quartz; and at least one metal oxide selected from MnO, NiO, CuO, and ZnO, wherein an amount of the metal oxide is 0.05 parts by weight to 2 parts by weight relative to a total 100 parts by weight of the glass and the filler.

### CROSS REFERENCE TO RELATED APPLICATIONS

The present application is a continuation of International application No. PCT/JP2022/009046, filed Mar. 3, 2022, which claims priority to Japanese Patent Application No. 2021-040275, Mar. 12, 2021, the entire contents of each of which are incorporated herein by reference.

### TECHNICAL FIELD

The present invention relates to a glass ceramic material, a laminate, and an electronic component.

### BACKGROUND ART

In recent years, sintered products of dielectric materials that can be co-fired with conductor materials at a temperature of 1000° C. or lower have been used for multilayer ceramic substrates. For example, Patent Literature 1 discloses a glass-ceramic composite material containing borosilicate glass (50 to 90%) containing SiO₂ (70 to 85%), B₂O₃ (10 to 25%), K₂O (0.5 to 5%), and Al₂O₃ (0.01 to 1%) and at least one SiO₂ filler (10 to 50%) selected from the group consisting of α-quartz, α-cristobalite, and β-tridymite.

Patent Literature 1: JP 2002-187768 A

### SUMMARY OF THE INVENTION

At the time of firing of a glass-ceramic composite material (hereinafter also referred to as a “glass ceramic material”), densification proceeds due to viscous flow of the glass while the maximum temperature is retained. When a certain amount of materials subjected to firing is introduced into a firing furnace, variation will occur in the time taken to reach the maximum temperature among the materials subjected to firing. This requires adjustment for extension of the retention time so that a material subjected to firing which is behind in reaching the maximum temperature will be sufficiently densified.

However, when the retention time at the maximum temperature is extended at the time of firing, pores will be generated due to gasification of a carbon component remaining in a trace amount at a more quickly densified portion. When the pores are enclosed in a sintered product obtained after firing, the pores will not be discharged to the outside but will remain as voids. This causes problems in the resulting sintered product such as low density and poor insulation. In particular, a glass ceramic material containing a large amount of SiO₂ component as in Patent Literature 1 has a relatively high glass viscosity at the maximum temperature at the time of firing. This requires extension of the retention time at the maximum temperature at the time of firing, which accentuates the problems described above.

The present invention is made to solve the above problems. The present invention aims to provide a glass ceramic material capable of producing a dense sintered product even when the retention time at the maximum temperature is extended at the time of firing; a laminate including a stack of multiple glass ceramic layers made of a sintered product of the glass ceramic material; and an electronic component including the laminate.

The glass ceramic material of the present invention contains: glass containing SiO₂, B₂O₃, and M₂O, where M is an alkali metal; filler containing quartz; and at least one metal oxide selected from the group consisting of MnO, NiO, CuO, and ZnO, wherein an amount of the metal oxide is 0.05 parts by weight to 2 parts by weight relative to a total 100 parts by weight of the glass and the filler.

The laminate of the present invention includes a stack of multiple glass ceramic layers made of a sintered product of the glass ceramic material.

The electronic component of the present invention includes the laminate.

The present invention can provide a glass ceramic material capable of producing a dense sintered product even when the retention time at the maximum temperature is extended at the time of firing; a laminate including a stack of multiple glass ceramic layers made of a sintered product of the glass ceramic material; and an electronic component including the laminate.

### BRIEF DESCRIPTION OF THE DRAWINGS

FIG. 1 is a schematic cross-sectional view showing an example of the laminate of the present invention.

FIG. 2 is a schematic cross-sectional view showing an example of the electronic component of the present invention.

### DETAILED DESCRIPTION OF THE PREFERRED EMBODIMENTS

Hereinafter, the glass ceramic material, the laminate, and the electronic component of the present invention are described. The present invention is not limited to the following preferred embodiments, and may be suitably modified without departing from the gist of the present invention. Combinations of two or more preferred features described in the following preferred embodiments are also within the scope of the present invention.

The glass ceramic material of the present invention is a low temperature co-fired ceramic (LTCC) material. Herein, the term “low temperature co-fired ceramic material” refers to a glass ceramic material capable of being sintered at a firing temperature of 1000° C. or lower.

### Glass Ceramic Material

The glass ceramic material of the present invention contains glass containing SiO₂, B₂O₃, and M₂O, where M is an alkali metal; filler containing quartz; and at least one metal oxide selected from the group consisting of MnO, NiO, CuO, and ZnO, wherein an amount of the metal oxide is 0.05 parts by weight to 2 parts by weight relative to a total 100 parts by weight of the glass and the filler.

Since the glass ceramic material of the present invention contains a specific amount of the metal oxide, densification proceeds uniformly even when the retention time at the maximum temperature is extended at the time of firing. Thus, a dense sintered product can be obtained.

### Glass

In the glass ceramic material of the present invention, the glass contains SiO₂, B₂O₃, and M₂O, where M is an alkali metal.

SiO₂ in the glass contributes to a decrease in dielectric constant when the glass ceramic material is fired. This, as a result, reduces or prevents stray capacitance associated with an increase in frequency of electric signals, for example.

B₂O₃ in the glass contributes to a decrease in glass viscosity. Thus, a sintered product of the glass ceramic material is rendered dense.

M₂O in the glass contributes to a decrease in glass viscosity. Thus, a sintered product of the glass ceramic material is rendered dense. M₂O is not limited as long as it is an alkali metal oxide but is preferably Li₂O, K₂O, or Na₂O, more preferably K₂O. One type of M₂O may be used, or several types thereof may be used.

The amount of SiO₂ in the glass is preferably 65 wt % to 90 wt % in terms of oxide. The amount is more preferably 70 wt % to 85 wt %.

The amount of B₂O₃ in the glass is preferably 5 wt % to 30 wt % in terms of oxide. The amount is more preferably 10 wt % to 25 wt %.

The amount of M₂O in the glass is preferably 1 wt % to 5 wt % in terms of oxide. The amount is more preferably 1.5 wt % to 4.5 wt %. When several alkali metal oxides are used as M₂O, the total amount thereof is regarded as the amount of M₂O.

The glass may further contain Al₂O₃. Al₂O₃ in the glass contributes to an improvement in chemical stability of the glass.

When the glass contains Al₂O₃, the amount of Al₂O₃ in the glass is preferably 0.1 wt % to 2 wt % in terms of oxide. The amount is more preferably 0.5 wt % to 1 wt %.

The glass may further contain an alkaline earth metal oxide such as CaO. However, from a viewpoint of reducing the dielectric constant and dielectric loss by increasing the amount of SiO₂ in the glass, preferably, the glass contains no alkaline earth metal oxide. Even when the glass contains an alkaline earth metal oxide, the amount thereof in the glass is preferably less than 15 wt %, more preferably less than 5 wt %, still more preferably less than 1 wt %.

The glass may contain impurities in addition to the above components. The amount of impurities in the glass is preferably less than 5 wt %, more preferably less than 1 wt %.

### Filler

In the glass ceramic material of the present invention, the filler contains quartz. The filler contributes to an improvement in mechanical strength when the glass ceramic material is fired. Herein, the term “filler” refers to an inorganic additive not contained in the glass.

The quartz in the filler contributes to an increase in thermal expansion coefficient when the glass ceramic material is fired. While the glass has a thermal expansion coefficient of about 6 ppm/K, the quartz has a thermal expansion coefficient of about 15 ppm/K. Thus, the presence of the quartz in the glass ceramic material results in a high thermal expansion coefficient when the glass ceramic material is fired. Thus, compressive stress is generated during cooling after firing, which increases the mechanical strength (e.g., bending strength) and which also increases the reliability at the time of mounting of the laminate onto a board (e.g., a resin board).

The filler may contain only quartz but may further contain SiO₂ other than quartz. The filler may further contain Al₂O₃ and/or ZrO₂.

The presence of Al₂O₃ and ZrO₂ as the filler in the glass ceramic material prevents precipitation of cristobalite crystals when the glass ceramic material is fired. Cristobalite crystals, which are a type of SiO₂ crystals, undergo a phase transition at about 280° C. Thus, precipitation of cristobalite crystals during firing of the glass ceramic material will significantly change the volume of the glass ceramic material in a high temperature environment, decreasing the reliability. Al₂O₃ and ZrO₂ in the filler also contribute to a decrease in dielectric loss, an increase in thermal expansion coefficient, and an increase in mechanical strength when the glass ceramic material is fired.

When the filler contains Al₂O₃ and Zr₂, the amount of each is preferably 1 wt % to 5 wt %.

More preferably, the filler contains only quartz.

Preferably, the glass ceramic material of the present invention contains the glass in an amount of 50 parts by weight to 90 parts by weight and the filler in an amount of parts by weight to 50 parts by weight relative to a total 100 parts by weight of the glass and the filler. More preferably, the amount of the glass is 60 parts by weight to parts by weight, and the amount of the filler is 20 parts by weight to 40 parts by weight.

### Metal Oxide

The glass ceramic material of the present invention contains at least one metal oxide selected from the group consisting of MnO, NiO, CuO, and ZnO, and the metal oxide is contained in an amount of 0.05 parts by weight to 2 parts by weight relative to a total 100 parts by weight of the glass and the filler. When several metal oxides are used, the total of all the metal oxides used is adjusted to 0.05 parts by weight to 2 parts by weight relative to a total 100 parts by weight of the glass and the filler.

A dense sintered product having a high relative density can be obtained even when the firing time is extended, owing to the presence of the metal oxide(s) in an amount in the above range in the glass ceramic material of the present invention. Such a sintered product is excellent in terms of dielectric constant and Q factor (reciprocal of dielectric loss). The metal oxide is preferably CuO.

As described above, densification of the glass ceramic material of the present invention proceeds uniformly even when the firing time is extended, so that a dense sintered product can be obtained. The glass and the filler in a sintered product of the glass ceramic material can be discriminated from each other by analyzing electron diffraction patterns under a transmission electron microscope (TEM).

The actual compositional makeup of a sintered product of the glass ceramic material (described later) may be used as the compositional makeup of the glass ceramic material of the present invention. For example, a glass ceramic material containing a large amount of SiO₂ component as in Patent Literature 1 has a relatively high glass viscosity at the maximum temperature at the time of firing as described above. Thus, precipitation of crystals from the glass, for example, is less likely to occur during firing. In this case, there is no problem in considering that the compositional makeup of the glass ceramic material of the present invention is substantially the same as the compositional makeup of a sintered product of the glass ceramic material.

### Laminate

The laminate of the present invention includes a stack of multiple glass ceramic layers made of a sintered product of the glass ceramic material of the present invention. The multiple glass ceramic layers may each have the same compositional makeup or a different compositional makeup, but preferably, these glass ceramic layers have the same compositional makeup.

The relative density of the laminate is preferably 90% or more, more preferably 95% or more. The relative density is the quotient of the apparent density determined by the Archimedes method divided by the true density. The true density is the density of powder obtained by grinding the laminate. The apparent density is the density including voids. The volume ratio of voids in the laminate can be calculated by dividing the apparent density by the true density. When the relative density is 100%, it means that the laminate includes no voids.

The dielectric constant of the laminate is preferably 4.5 or less. The dielectric constant is measured at 3 GHz by the perturbation method.

Q factor which is the reciprocal of the dielectric loss of the laminate is preferably 250 or more. Q factor is calculated as the reciprocal of the dielectric loss at 3 GHz by the perturbation method.

The laminate of the present invention may further include a conductor layer. The conductor layer is disposed between the glass ceramic layers adjacent to each other in a stacking direction and/or on a surface of the glass ceramic layer.

The laminate of the present invention may further include a via conductor. The via conductor is disposed to penetrate the glass ceramic layer.

The conductor layer and the via conductor can be formed by screen printing, photolithography, or the like using a conductive paste containing Ag or Cu.

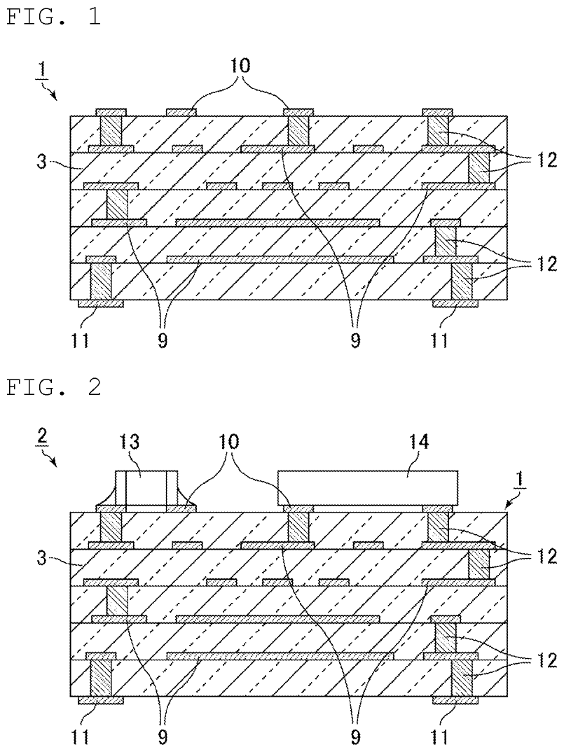

FIG. 1 is a schematic cross-sectional view showing an example of the laminate of the present invention. As shown in FIG. 1, the laminate of the present invention may be used as a multilayer ceramic substrate. A laminate (multilayer ceramic substrate) 1 shown in FIG. 1 includes a stack of multiple glass ceramic layers 3 (five layers in FIG. 1).

The laminate 1 may include conductor layers 9, 10, and 11 and via conductors 12. For example, these conductor layers and via conductors may define passive elements such as capacitors and inductors or may define connecting wires for electric connection between elements.

Preferably, the conductor layers 9, 10, and 11 and the via conductors 12 each contain Ag or Cu as a main component. Use of such a low-resistance metal prevents the occurrence of signal propagation delay associated with an increase in frequency of electric signals. The glass ceramic layers 3 are made of the glass ceramic material of the present invention, i.e., a low temperature co-fired ceramic material, and thus can be co-fired with Ag or Cu.

The conductor layers 9 are inside the laminate 1. Specifically, each conductor layer 9 is between two glass ceramic layers 3 adjacent to each other in the stacking direction.

The conductor layers 10 are on one of main surfaces of the laminate 1.

The conductor layers 11 are on the other main surface of the laminate 1.

Each via conductor 12 is disposed to penetrate the glass ceramic layer 3 and plays a role in electrically connecting the conductor layers 9 at different levels to each other, electrically connecting the conductor layers 9 and 10 to each other, or electrically connecting the conductor layers 9 and 11 to each other.

A multilayer ceramic substrate, which is as an example of the laminate of the present invention, is produced as described below, for example.

### (A) Preparation of Glass Ceramic Material

The glass ceramic material of the present invention is prepared by mixing glass, filler, and a metal oxide at a predetermined compositional makeup.

### (B) Production of Green Sheets

The glass ceramic material of the present invention is mixed with a binder, a plasticizer, and the like to prepare a ceramic slurry. Then, the ceramic slurry is applied to a base film (e.g., a polyethylene terephthalate (PET) film) and dried, whereby a green sheet is produced.

### (C) Production of Laminated Green Sheets

The green sheets are stacked to produce unfired laminated green sheets. The laminated green sheets may include conductor layers and via conductors formed therein.

### (D) Firing of Laminated Green Sheets

The laminated green sheets are fired. As a result, the laminate (multilayer ceramic substrate) 1 shown in FIG. 1 is obtained.

The firing temperature of the laminated green sheets is not limited as long as it is a temperature at which the glass ceramic material of the present invention defining the green sheets can be sintered. For example, the firing temperature may be 1000° C. or lower.

The firing atmosphere of the laminated green sheets is not limited. Yet, when the conductor layers and the via conductors are made of a material resistant to oxidation, such as Ag, an air atmosphere is preferred; while when the conductor layers and the via conductors are made of a material prone to oxidation, such as Cu, a hypoxic atmosphere such as a nitrogen atmosphere is preferred. The firing atmosphere of the laminated green sheets may be a reducing atmosphere.

The laminated green sheets may be fired in a state of being sandwiched by restraint green sheets. The restraint green sheets contain, as a main component, an inorganic material (e.g., Al₂O₃₎that is not substantially sintered at a sintering temperature of the glass ceramic material of the present invention defining the green sheets. Thus, the restraint green sheets do not shrink at the time of firing of the laminated green sheets but act to reduce or prevent shrinkage in the main surface direction of the laminated green sheets. This, as a result, improves the dimensional accuracy of the resulting laminate 1 (in particular, the conductor layers 9, 10, and 11, and the via conductors 12).

When the laminate of the present invention includes conductor layers, preferably, the main component of the conductor layers is Cu, and the metal oxide in the glass ceramic layer includes at least CuO.

In the case of conventional laminated green sheets, when the main component of the conductor layers is Cu, diffusion of Cu occurs from the conductor layers to the laminated green sheets at the time of firing, resulting in non-uniform and slow sintering. Presumedly, such problems occur because the amount of Cu diffused is large at portions near the conductor layers so that sintering proceeds slowly there, while the amount of Cu diffused at portions away from the conductor layers is small so that sintering proceeds quickly there. In contrast, in the case of laminated green sheets produced by adding CuO as a metal oxide to a glass ceramic material, presumably, non-uniform sintering is unlikely to occur because CuO is already diffused in the laminated green sheets before firing.

Herein, that the main component of the conductor layers is Cu means that at least 90 vol % of the conductor layers is made of Cu. Preferably, the conductor layers are made of a mixture of Cu, glass, and an aluminum oxide. The glass for use in forming the conductor layers can be the same as the glass in the glass ceramic material of the present invention, for example.

That the metal oxide includes at least CuO means that the metal oxide includes only CuO or that the metal oxide includes CuO and one or more additional metal oxides other than CuO. More preferably, the metal oxide includes only CuO.

When the laminate of the present invention includes via conductors, preferably, the main component of the via conductors is Cu, and the metal oxide in the glass ceramic layer includes at least CuO.

### Electric Component

The electronic component of the present invention includes the laminate of the present invention.

The electronic component of the present invention includes, for example, a multilayer ceramic substrate, which is an example of the laminate of the present invention, and a chip component mounted on the multilayer ceramic substrate. Examples of the chip component include LC filters, capacitors, and inductors.

FIG. 2 is a schematic cross-sectional view showing an example of the electronic component of the present invention. As shown in FIG. 2, chip components 13 and 14 may be mounted on the laminate (multilayer ceramic substrate) 1 while being electrically connected to the conductor layers 10. Thus, an electronic component 2 including the laminate 1 is configured.

The electronic component 2 may be mounted on a mounting board (e.g., motherboard) in an electrically connected manner via the conductor layers 11.

An example has been described in which the laminate of the present invention is used as a multilayer ceramic substrate, but the laminate of the present invention may also be used as a chip component to be mounted on a multilayer ceramic substrate. In other words, the laminate of the present invention may be used as an LC filter, a capacitor, an inductor, or the like. For example, when the laminate of the present invention is used as a capacitor, the laminate includes a conductor layer between the glass ceramic layers adjacent to each other in the stacking direction.

The laminate of the present invention may be used as a product other than the multilayer ceramic substrate and the chip component.

### EXAMPLES

Hereinafter, examples that more specifically disclose the present invention are described. The present invention is not limited to these examples.

### Preparation of Glass Powder

Frit powders G1 to G4 each having a compositional makeup shown in Table 1 were mixed and placed in a crucible made of Pt and melted in an air atmosphere at 1600° C. for 30 minutes or longer. Subsequently, the resulting molten product was quenched to obtain cullet. Here, a carbonate was used as a raw material of K₂O (an alkali metal oxide) in Table 1. In Table 1, the amount of K₂O indicates the percentage of the carbonate in terms of oxide. The cullet was coarsely ground and then placed in a container together with ethanol and PSZ balls (diameter: 5 mm) and mixed in a ball mill. When mixing in the ball mill, the grinding time was adjusted, whereby a glass powder having a median particle size of 1 μm was obtained. Here, the term “median particle size” refers to the median particle size D₅₀ determined by the laser diffraction scattering method.

TABLE 1

Compositional makeup (wt %)

| Glass | SiO₂ | B₂O₃ | K₂O | Al₂O₃ |
|---|---|---|---|---|
| G1 | 70.0 | 25.0 | 4.0 | 1.0 |
| G2 | 75.0 | 20.0 | 4.5 | 0.5 |
| G3 | 80.0 | 18.0 | 1.5 | 0.5 |
| G4 | 85.0 | 10.0 | 4.0 | 1.0 |

### Preparation of Glass Ceramic Material

A glass powder, a quartz powder as filler, and a metal oxide were placed in ethanol and mixed in a ball mill according to the compositional makeup shown in Table 2, whereby a glass ceramic material was prepared. The quartz powder and the metal oxide each had a median particle size of 1 μm.

### Production of Green Sheets

The glass ceramic material prepared above, a solution of polyvinyl butyral in ethanol as a binder solution, and a dioctyl phthalate (DOP) solution as a plasticizer were mixed, whereby a ceramic slurry was prepared. Then, the ceramic slurry was applied to a polyethylene terephthalate film using a doctor blade and dried at 40° C., whereby green sheets S1 to S29 each having a thickness of 50 μm were produced.

TABLE 2

| | | | | | | | | | | Relative | | |
|---|---|---|---|---|---|---|---|---|---|---|---|---|
| | Green | Compositional makeup (wt %) | | | | | | | Firing time | density | Dielectric | |
| | sheets | Glass | | Filler | MnO | NiO | CuO | ZnO | (min) | (%) | constant | Q factor |
| Comparative Example 1 | S1 | G1 | 70 | 30 | — | — | — | — | 30 | 97 | 4.1 | 280 |
| Comparative Example 2 | S2 | G2 | 70 | 30 | — | — | — | — | 120 | 90 | 3.8 | 250 |
| Comparative Example 3 | S3 | G3 | 70 | 30 | — | — | — | — | 180 | 87 | 3.6 | 240 |
| Example 1 | S4 | G4 | 70 | 30 | — | — | 0.05 | — | 180 | 98 | 4.1 | 340 |
| Example 2 | S5 | G1 | 70 | 30 | — | — | 0.1 | — | 180 | 97 | 4.1 | 330 |
| Example 3 | S6 | G2 | 70 | 30 | — | — | 0.5 | — | 180 | 97 | 4.1 | 300 |
| Example 4 | S7 | G3 | 70 | 30 | — | — | 1 | — | 180 | 98 | 4.2 | 280 |
| Example 5 | S8 | G4 | 70 | 30 | — | — | 2 | — | 180 | 98 | 4.2 | 270 |
| Comparative Example 4 | S9 | G1 | 70 | 30 | — | — | 5 | — | 180 | 96 | 4.3 | 200 |
| Example 6 | S10 | G2 | 70 | 30 | 0.5 | — | — | — | 180 | 96 | 4.1 | 320 |
| Example 7 | S11 | G3 | 70 | 30 | — | 0.5 | — | — | 180 | 96 | 4.1 | 330 |
| Example 8 | S12 | G4 | 70 | 30 | — | — | — | 0.5 | 180 | 96 | 4.1 | 310 |
| Example 9 | S13 | G4 | 70 | 30 | — | — | — | 0.05 | 180 | 96 | 4.1 | 320 |
| Example 10 | S14 | G4 | 70 | 30 | — | — | — | 2 | 180 | 97 | 4.2 | 310 |
| Comparative Example 5 | S15 | G4 | 70 | 30 | — | — | — | 5 | 180 | 96 | 4.3 | 180 |
| Example 11 | S16 | G4 | 70 | 30 | — | 0.05 | — | — | 180 | 96 | 4.1 | 330 |
| Example 12 | S17 | G4 | 70 | 30 | — | 2 | — | — | 180 | 97 | 4.1 | 310 |
| Comparative Example 6 | S18 | G4 | 70 | 30 | — | 5 | — | — | 180 | 96 | 4.1 | 200 |
| Example 13 | S19 | G4 | 70 | 30 | 0.05 | — | — | — | 180 | 95 | 4.1 | 310 |
| Example 14 | S20 | G4 | 70 | 30 | 2 | — | — | — | 180 | 96 | 4.1 | 300 |
| Comparative Example 7 | S21 | G4 | 70 | 30 | 5 | — | — | — | 180 | 96 | 4.1 | 190 |
| Comparative Example 8 | S22 | G4 | 70 | 30 | — | — | 0.03 | — | 180 | 88 | 3.7 | 250 |
| Comparative Example 9 | S23 | G4 | 70 | 30 | — | — | 0.04 | — | 180 | 92 | 3.9 | 250 |
| Comparative Example 10 | S24 | G4 | 70 | 30 | — | — | — | 0.03 | 180 | 88 | 3.6 | 240 |
| Comparative Example 11 | S25 | G4 | 70 | 30 | — | — | — | 0.04 | 180 | 92 | 4.0 | 240 |
| Comparative Example 12 | S26 | G4 | 70 | 30 | — | 0.03 | — | — | 180 | 87 | 3.6 | 260 |
| Comparative Example 13 | S27 | G4 | 70 | 30 | — | 0.04 | — | — | 180 | 93 | 4.0 | 250 |
| Comparative Example 14 | S28 | G4 | 70 | 30 | 0.03 | — | — | — | 180 | 87 | 3.6 | 260 |
| Comparative Example 15 | S29 | G4 | 70 | 30 | 0.04 | — | — | — | 180 | 91 | 4.0 | 260 |

### Production of Sample for Evaluation, and Evaluation

Each of the green sheets S1 to S29 was cut into 50-mm square pieces, and 20 of these pieces of the same type were stacked, placed in a mold, and subjected to compression bonding using a pressing machine. The resulting laminated green sheets were fired in an air atmosphere at 900° C. for 30 to 180 minutes. The firing time is as shown in Table 2. After firing, the apparent density of the resulting laminate was determined by the Archimedes method, and the dielectric constant at 3 GHz and Q factor (reciprocal of dielectric loss) thereof were determined by the perturbation method. Subsequently, the laminate was ground, and the true density of the powder was determined.

The relative density as the quotient of the apparent density determined by the Archimedes method divided by the true density was calculated in percent as shown in the following formula.

(Apparent density)/(true density)×100=relative density (%)

Table 2 shows the evaluation results.

The laminate was determined as being dense when the relative density was 95% or more. The laminate was determined as having a low dielectric constant when the dielectric constant was 4.5 or less and was determined as having a low dielectric loss when the Q factor was 250 or more.

The laminates of Examples 1 to 14 each had a relative density of 95% or more, a dielectric constant of 4.5 or less, and a Q factor of 250 or more.

Among the laminates of Comparative Examples 1 to 3 in which no metal oxide such as MnO was used, the laminate in Comparative Example 1 with a short firing time had an appropriate relative density, an appropriate dielectric constant, and an appropriate Q factor, while the laminates in Comparative Examples 2 and 3 with a firing time of 120 minutes or longer each had a relative density of 90% or less. The Q factor was also low in Comparative Example 3.

The laminates of Comparative Examples 4 to 7 each had a low Q factor, with the amount of the metal oxide being more than 2 parts by weight.

The laminates of Comparative Examples 8 to 15 each had a low relative density, with the amount of the metal oxide being less than 0.05 parts by weight. The Q factor was also low in Comparative Examples 10 and 11.

### REFERENCE SIGNS LIST

1 laminate (multilayer ceramic substrate)

2 electronic component

3 glass ceramic layer

9, 10, 11 conductor layer

12 via conductor

13, 14 chip component

1. A glass ceramic material comprising:
glass containing SiO₂, B₂O₃, and M₂O, where M is an alkali metal;
filler containing quartz; and
at least one metal oxide selected from the group consisting of MnO, NiO, CuO, and ZnO,
wherein an amount of the metal oxide is 0.05 parts by weight to 2 parts by weight relative to a total 100 parts by weight of the glass and the filler.

2. The glass ceramic material according to claim 1, wherein the M₂O is one or more of Li₂O, K₂O, and Na₂O.

3. The glass ceramic material according to claim 1, wherein the glass contains the SiO₂ in an amount of 65 wt % to 90 wt % in terms of oxide.

4. The glass ceramic material according to claim 1, wherein the glass contains the SiO₂ in an amount of 70 wt % to 85 wt % in terms of oxide.

5. The glass ceramic material according to claim 1, wherein the glass contains the B₂O₃ in an amount of 5 wt % to 30 wt % in terms of oxide.

6. The glass ceramic material according to claim 1, wherein the glass contains the M₂O in an amount of 1 wt % to 5 wt % in terms of oxide.

7. The glass ceramic material according to claim 1,
wherein the glass contains the SiO₂ in an amount of 70 wt % to 85 wt % in terms of oxide, and
an amount of B₂O₃ in the glass is 10 wt % to 30 wt % in terms of oxide.

8. The glass ceramic material according to claim 1,
wherein the glass contains the SiO₂ in an amount of 70 wt % to 85 wt % in terms of oxide, and
an amount of the B₂O₃ in the glass is 10 wt % to 25 wt % in terms of oxide.

9. The glass ceramic material according to claim 1, wherein the glass further contain Al₂O₃.

10. The glass ceramic material according to claim 9, wherein an amount of the Al₂O₃ in the glass is 0.1 wt % to 2 wt % in terms of oxide.

11. The glass ceramic material according to claim 1, wherein a thermal expansion coefficient of the quartz in the filler is higher than a thermal expansion coefficient of the glass.

12. The glass ceramic material according to claim 1, wherein the filler further contains at least one of Al₂O₃ and ZrO₂.

13. The glass ceramic material according to claim 1, wherein the filler contains only the quartz.

14. The glass ceramic material according to claim 1, wherein the glass ceramic material contains the glass in an amount of 50 parts by weight to 90 parts by weight and the filler in an amount of 10 parts by weight to 50 parts by weight relative to a total 100 parts by weight of the glass and the filler.

15. A laminate comprising:
a stack of multiple glass ceramic layers made of a sintered product of the glass ceramic material according to claim 1.

16. The laminate according to claim 15, further comprising a conductor layer at least one of (1) between glass ceramic layers adjacent to each other in a stacking direction of the stack of the multiple glass ceramic layers or (2) on a surface of a glass ceramic layer of the stack of the multiple glass ceramic layers.

17. The laminate according to claim 16, wherein the conductor layer contains Cu as a main component thereof, and the metal oxide in the glass ceramic layer includes at least CuO.

18. An electronic component comprising:
the laminate according to claim 1; and
a conductor layer on the laminate.
